(19) United States
(12) Patent Application Publication
(10) Pub. No.: US 2010/0270885 A1
(43) Pub. Date: Oct. 28, 2010

(54) MAGNETIC DRIVEN MOTOR FOR GENERATING TORQUE AND PRODUCING ENERGY

(76) Inventor: Santiago Ojeda Izquierdo, Las Vegas, NV (US)

Correspondence Address: SNELL & WILMER LLP (OC), 600 ANTON BOULEVARD, SUITE 1400, COSTA MESA, CA, 92626, US

(21) Appl. No.: 12/766,789

(22) Filed: Apr. 23, 2010

Related U.S. Application Data
(60) Provisional application No. 61/172,171, filed on Apr. 23, 2009.

(51) Int. Cl. H02K 21/00; H02N 11/00

(52) U.S. Cl. 310/152; 415/916

(57) ABSTRACT

The present invention relates generally to a motor that may generate torque and produce energy. The motor comprises a drive shaft configured to rotate about an axis, a first flywheel coupled to the drive shaft, a force transmission device coupled to the drive shaft, and a first shielding device coupled to the drive shaft and positioned between the first flywheel and the force transmission device. A first piston dolly is coupled to the force transmission device, the first piston dolly configured to move laterally along the axis of the drive shaft. A first magnetic device is coupled to the first piston dolly. In addition, a second piston dolly is also coupled to the force transmission device, the second piston dolly configured to move laterally along the axis of the drive shaft. A second magnetic device is coupled to the second piston dolly.

### CLAIM OF PRIORITY UNDER 35 U.S.C. §119

The present Application for Patent claims priority to and the benefit of U.S. Provisional Patent Application Ser. No. 61/172,171, filed on Apr. 23, 2009, and hereby expressly incorporated by reference herein.

### FIELD

The present invention relates generally to the field of magnetically driven motors. More specifically, to the field of magnetically driven motors capable of generating torque and producing energy.

### BACKGROUND

Conventional motors typically rely on a defined input power source to produce an output, may it be a mechanical or electrical output. Such motors typically rely on magnetic generators to either convert an electrical input to a mechanical output, or to convert a mechanical input to an electrical output. Although these motors may include numerous magnetic sources, and rely on the electromotive force to operate, few utilize these magnetic sources to actually provide, or enhance the input power supplied to the motor.

In addition, motors that rely on magnets for an input force will wear down and stop operating over time due to friction forces existing between component parts and magnetic devices. Such devices may operate for a short time, but can not continuously operate over an extended period of time.

Thus, there is a present need in the art for a motor that may generate torque and produce energy that utilizes magnetic devices as an input force, and may also operate for more than a brief period of time.

### SUMMARY

One embodiment of the invention provides a motor that may generate torque and produce energy, comprising a drive shaft configured to rotate about an axis, a first flywheel coupled to the drive shaft, a force transmission device coupled to the drive shaft, and a first shielding device coupled to the drive shaft and positioned between the first flywheel and the force transmission device. A first piston dolly is coupled to the force transmission device, the first piston dolly being configured to move laterally along the axis of the drive shaft. A first magnetic device is coupled to the first piston dolly. In addition, a second piston dolly is also coupled to the force transmission device, the second piston dolly being configured to move laterally along the axis of the drive shaft. A second magnetic device is coupled to the second piston dolly. Furthermore, a second flywheel may be attached to the drive shaft, and a second shielding device may also be coupled to the second end of the drive shaft.

The motor may operate to either generate torque or produce energy (e.g., electrical energy) or may operate to generate both torque and energy. In operation, a first magnetic device is magnetically engaged with a magnetic device coupled to one of the flywheels; in other words, the first magnetic device feels a magnetic force exerted by the magnetic device coupled to one of the flywheels. In addition, the magnetic device coupled to one of the flywheels feels a magnetic force exerted by the first magnetic device. Multiple magnetic devices are coupled to the flywheels. The polarity of the magnetic device engaged with the first magnetic device causes the first piston dolly to move in a direction along the axis of the shaft. The movement of the first piston dolly causes the flywheel to rotate. When the flywheel rotates, a different magnetic device magnetically engages with the first magnetic device. The different magnetic device may have a different polarity, causing the first piston dolly to move in an opposite direction along the axis of the shaft. The first piston dolly continues to move in directions away and towards the flywheel, causing the flywheel to rotate. In addition, the motion of the first piston dolly causes the drive shaft to rotate, producing a torque. A shielding device may selectively expose the first magnetic device to the magnetic devices on the flywheels.

In an embodiment of the present invention, a second piston dolly may be coupled to the force transmission device, to form a four-pulse motor. In addition, a third and fourth piston dolly may be coupled to the force transmission device, to form an eight-pulse motor. Each piston dolly travels laterally along the axis of the drive shaft between the shielding devices, and outputs a torque to the drive shaft.

In an embodiment of the present invention, anti-lock dollies may be coupled to the first and second piston dollies. The anti-lock dollies may aid or contribute to assure the motor will not lock-up when exposed to a transition point between similar pole magnetic devices and opposite pole magnetic devices.

In an embodiment of the present invention, inductive coils may be positioned adjacent to the shielding devices. A portion of the magnetic devices located in the piston dollies may pass near an inductive coil, causing the inductive coil to produce a current. This current may be used to power the magnetic devices used in the motor or other devices outside the motor.

In an embodiment of the present invention, the flywheels may be slidably coupled to the drive shaft, allowing them to be slid towards and away from the shielding devices. The distance of the flywheels from the shielding devices defines the speed of the dollies' movement, and the total torque output by the motor.

In an embodiment of the present invention, a timed force device comprising pulleys, or the equivalent, is engaged with the motor. The timed force device selectively applies a force to the motor at or near a lock-up point to aid proper operation of the motor. The timed force device may be coupled to flywheels, with magnetic devices attached thereto, or directly to the shaft.

In an embodiment of the present invention, the magnetic devices in the flywheels may be variably positioned relative to respective surfaces of the flywheels, or may be slidably positioned within the flywheels. The variable positions or slidable positions help to assure the motor will not lock-up when exposed to similar pole magnetic devices.

In an embodiment of the present invention, electric generator devices may be coupled to the flywheels or to the drive shaft. These devices output energy from the motor that may be used to power the magnetic devices used in the motor or other devices outside the motor.

In an embodiment of the present invention, a torque device may be coupled to the drive shaft, to deliver a torque to the drive shaft when the motor is near a lock-up point. The delivered torque helps to assure the motor will not lock-up when exposed to similar pole magnetic devices.

### BRIEF DESCRIPTION OF THE DRAWINGS

FIG. 1 illustrates a side view of a magnetic driven system (e.g., a motor) having a drive shaft, first and second flywheels, a force transmission device, first and second shielding devices, bearings, magnetic devices and anti-lock dollies.

FIG. 2A illustrates a perspective view of the system for a 4-pulse motor (two piston dollies with two magnetic devices per dolly) where the force transmission device is a swash plate.

FIG. 2B illustrates a perspective view of the system for an 8-pulse motor (four piston dollies with two magnetic devices per dolly) where force transmission device is a swash plate.

FIG. 3 illustrates a front schematic view of the shielding device with different apertures to expose the magnetic devices for an 8-pulse motor.

FIG. 4 illustrates a front schematic view of the shielding device with different apertures to expose the magnetic devices for a 4-pulse motor.

FIG. 5 illustrates a front schematic view of one of the flywheels with a plurality of magnetic devices.

FIG. 6 illustrates a front schematic view of one of the flywheels with a plurality of magnetic devices having a different shape than the magnetic devices shown in FIG. 5.

FIG. 7 illustrates a front schematic view of one of the flywheels with a plurality of magnetic devices and one of the shielding devices with apertures, showing one of the many different positions of the different magnetic devices as the attraction and repelling of the magnetic devices located in the dollies causes the dollies to move back and forth thereby causing the force transmission device to rotate which causes the drive shaft to rotate as well.

FIG. 8 illustrates a front schematic view of the other flywheel with a plurality of magnetic devices and the other shielding device with apertures, showing one of the many different positions of the different magnetic devices as the attraction and repelling of the magnetic devices located in the dollies causes the dollies to move back and forth thereby causing the force transmission device to rotate which causes the drive shaft to rotate as well.

FIG. 9 illustrates a side view of one of the dollies with one magnetic device being repelled by the like pole magnetic devices located in one of the flywheels.

FIG. 10 illustrates a side view of one of the dollies with one magnetic device being attracted by the opposite pole magnetic devices located in one of the flywheels.

FIG. 11 illustrates a side view of the motor where the magnetic devices located in one of the dollies get repelled by like pole magnetic devices located in one of the flywheels which causes the dollies to move along the axis of the shaft, which cause the force transmission device to rotate which causes the drive shaft to rotate, thus creating torque.

FIG. 12 illustrates a front schematic view of one of the shielding devices and one of the flywheels with a plurality of magnetic devices. The polarity of the magnetic devices causes the force transmission device to rotate which causes the drive shaft to rotate and subsequently the flywheel rotates as it is firmly attached to the drive shaft.

FIG. 13 illustrates a front schematic view of one of the shielding devices and one of the flywheels with a plurality of magnetic devices. The polarity of the magnetic devices causes the force transmission device to rotate which causes the drive shaft to rotate and subsequently the flywheel rotates as it is firmly attached to the drive shaft.

FIG. 14 illustrates a front schematic view of one of the shielding devices and one of the flywheels with a plurality of magnetic devices. The polarity of the magnetic devices causes the force transmission device to rotate which causes the drive shaft to rotate and subsequently the flywheel rotates as it is firmly attached to the drive shaft.

FIG. 15 illustrates a side view of the motor illustrating how throttling is achieved by moving in and out of the flywheels.

FIG. 16 illustrates a side view of the motor illustrating how throttling is achieved by moving in and out of the flywheels.

FIG. 17 illustrates a side view of the motor including a starter device.

FIG. 18 illustrates a side view of the motor including first and second electric generator devices.

FIG. 19 illustrates a top schematic view of one of the electric generator devices according to one embodiment of the present invention.

FIG. 20 illustrates a side view and plan layout view of the motor including an electrical processing system.

FIG. 21 illustrates a side view of the motor including timed force devices.

FIG. 22 illustrates a front schematic view of one of the timed force devices including a pulley system.

FIG. 23 illustrates a front schematic view of one of the timed force devices including a pulley system positioned in relation to one of the flywheels.

FIG. 24 illustrates a top schematic view of the magnetic devices coupled to one of the flywheels, and also the magnetic devices in the piston dollies.

FIG. 25 illustrates a top schematic view of the magnetic devices coupled to one of the flywheels, and also the magnetic devices in the piston dollies.

FIG. 26 illustrates a close-up perspective view of one of the magnetic devices.

FIG. 27 illustrates a side view and plan layout view of the motor including a torque device.

FIG. 28 illustrates a top schematic view of a traveling system comprising rails coupled to one of the piston dollies.

### DETAILED DESCRIPTION

Methods and systems that implement the embodiments of the various features of the invention will now be described with reference to the drawings. The drawings and the associated descriptions are provided to illustrate embodiments of the invention and not to limit the scope of the invention. Reference in the specifications to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, reference numbers are re-used to indicate correspondence between referenced elements.

In the following description, certain terminology is used to describe certain features of one or more embodiments of the invention. For instance, the term “magnetic devices” as described herein may include, but is not necessarily limited to, magnet, permanent magnets, electromagnets, solenoids, ferromagnetic materials, ferrites, etc. In addition, the term “motor” as described herein may include, but is not necessarily limited to an electric generator for producing a current, a generator for producing energy, a mechanical motor for outputting a torque, or combinations therein.

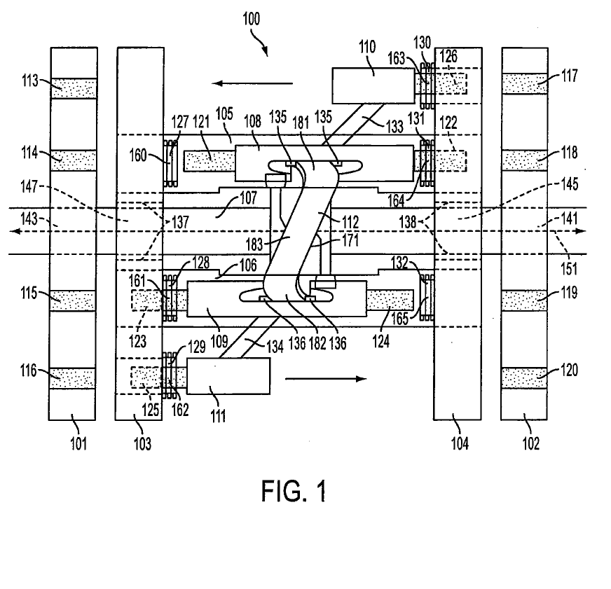

FIG. 1 illustrates a side view of a magnetic driven motor 100 (e.g., a motor, or generator) having a drive shaft 107, a first flywheel 102, and a second flywheel 101, a force transmission device 112, a first shielding device 104, a second shielding device 103, bearings 137 and 138, and magnetic devices 121, 122, 123, 124, 125 and 126. The drive shaft 107 is coupled to a force transmission device 112. The force transmission device 112 is coupled to a first piston dolly 108 and a second piston dolly 109 via bearings 135 and 136. The bearings 135 and 136 may be equivalently replaced with a system of rollers or followers, or any equivalent mechanism to transmit force from the force transmission device 112 to the first piston dolly 108 and second piston dolly 109. A first anti-lock dolly 110 is coupled to the first piston dolly 108 via a first support 133, and a second anti-lock dolly 111 is coupled to the second piston dolly 109 via a second support 134. The anti-lock dollies 110 and 111 may be positioned near, or at a distance from the respective first and second piston dollies 108 and 109, depending on the length and configuration of the respective first and second supports 133, 134. The anti-lock dollies 110 and 111 may be oriented to face in a direction parallel to the respective first and second piston dollies 108 and 109 (as illustrated in FIG. 1), or may be oriented at an angle with respect to the first and second piston dollies 108 and 109. The term piston dolly, or dolly, as used in the specification, generally refers to a mechanism capable of retaining a magnetic device and sliding laterally along the axis of the shaft. The piston dollies and anti-lock dollies may be equivalently replaced with carriages, chassis, housings, runners, or the like.

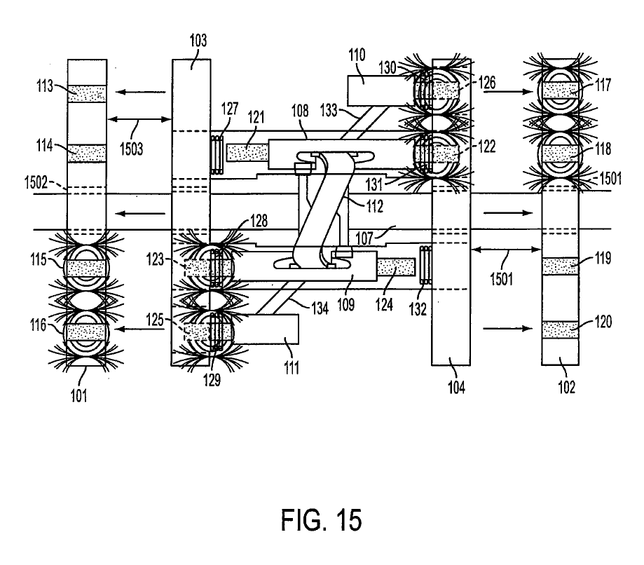

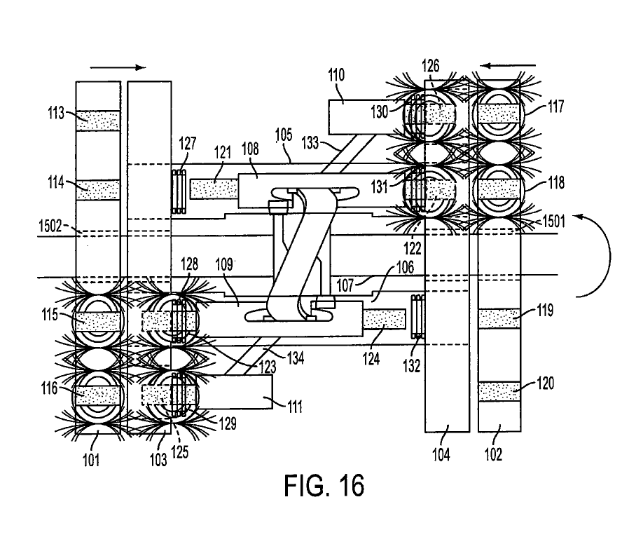

The drive shaft 107 may be firmly attached to the first flywheel 102 and second flywheel 101 and may rotate relative to the first shielding device 104 and second shielding device 103. In one embodiment, shown in FIGS. 15 and 16, the drive shaft 107 may be slidably coupled to the first flywheel 102 and second flywheel 101.

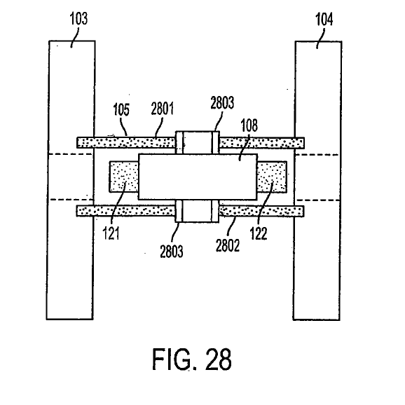

The first shielding device 104 and the second shielding device 103 have apertures, or cut-outs, that both selectively shield and expose magnetic devices 113, 114, 115, 116, 117, 118, 119 and 120 to and from the magnetic devices 121, 122, 123, 124, 125 and 126 coupled to the dollies 108, 109, 110 and 111. In addition, the first shielding device 104 and the second shielding device 103 may provide a support structure for the motor 100 and an attachment point for the traveling systems 105 and 106 for the piston dollies. Other structures may additionally be utilized to provide a support structure. The traveling systems 105 and 106 may comprise tubes, rails (as shown in FIG. 28), or the equivalent. The first shielding device 104 and the second shielding device 103 may be composed from a material that blocks transmission of magnetic forces, and/or substantially or partially blocks transmission of magnetic forces. In addition, the first and second shielding devices 104 and 103 may be partially composed of a material that blocks transmission of magnetic forces and may be combined with other non-shielding materials. The first and second shielding devices 104 and 103 may be used to support the entirety of the motor 100 and may be used to couple the motor 100 to an external frame.

The magnetic devices 113, 114, 115, 116, 117, 118, 119 and 120 are coupled to the first flywheel 102 and the second flywheel 101. The drive shaft 107 rotates along an axis 151 of the drive shaft 107, and rotates relative to the positions of the first shielding device 104 and second shielding device 103, which remain fixed and do not rotate along with the drive shaft 107 due to the bearings 137 and 138 or other equivalent frictionless motion methods.

The first flywheel 102, second flywheel 101, first shielding device 104 and second shielding device 103, each have a respective central region 141, 143, 145 and 147. The drive shaft 107 couples to the first and second flywheels 102 and 101, and the first and second shielding devices 104 and 103 at their respective central regions 141, 143, 145 and 147. The first and second flywheels 102 and 101, and the first and second shielding devices 104 and 103 each may extend in a direction perpendicular to the axis 151 of the drive shaft 107 and may have a substantially circular shape. It is additionally understood that the first and second flywheels 102 and 101, and the first and second shielding devices 104 and 103 each may extend in a non-perpendicular direction to the axis 151 of the drive shaft 107 and may have a non-circular shape, if the modified configuration operates similarly to the exemplary embodiment.

The force transmission device 112 shown in FIG. 1 has a first end 181, a second end 182 and a middle portion 183. The first piston dolly 108 couples to the first end 181, the second piston dolly 109 couples to the second end 182, and the drive shaft 107 couples to the middle portion 183. The first piston dolly 108 slidably couples to the first end 181 through the bearings 135 (or any other frictionless method), and the second piston dolly 109 slidably couples to the second end 182 through the bearings 136. The force transmission device 112 shown in FIG. 1 may comprise a sinusoidal cam 171, wherein the sinusoidal shape of the sinusoidal cam 171 allows the drive shaft 107 to rotate around the axis 151 in a single direction, when the first piston dolly 108 travels laterally along both directions along the axis 151 of the drive shaft 107.

The magnetic devices 121, 122, 123, 124, 125 and 126 are attached to the longitudinal sides of both types of dollies 108, 109, 110 and 111. The magnetic devices 121, 122, 123, 124, 125 and 126 may be positioned to face in a direction parallel with the dollies 108, 109, 110 and 111, or at an angle. However, it is understood that any of the magnetic devices 113-126 may be combined into a larger, unitary magnetic device. For example, the magnetic device 122 may be combined with magnetic device 121 to form a larger magnetic device with a first pole at one end of the first piston dolly 108 and a second pole at the second end of the first piston dolly 108. The polarities of the larger magnetic device may be different at both ends. Thus, it is understood that a magnetic device may be formed from combined magnetic devices, if the combination offers equivalent operation.

The magnetic devices 121, 122, 123, 124, 125 and 126 magnetically engage with the magnetic devices 113, 114, 115, 116, 117, 118, 119 and 120 located in the first flywheel 102 and second flywheel 101. In other words, the magnetic devices 121, 122, 123, 124, 125 and 126 respond to a magnetic field produced by the magnetic devices 113, 114, 115, 116, 117, 118, 119 and 120, and the magnetic devices 113, 114, 115, 116, 117, 118, 119 and 120 similarly respond to a magnetic field produced by the magnetic devices 121, 122, 123, 124, 125 and 126.

The piston dollies 108 and 109 are coupled to the force transmission device 112. The piston dollies 108 and 109 are configured to move laterally along the axis 151 of the drive shaft 107, from a position near the first shielding device 104 to a position near the second shielding device 103. Attached to the piston dollies 108 and 109 there may be anti-lock dollies 110 and 111 with magnetic devices 125 and 126 attached thereto, which aid in the rotation of the motor 100 by keeping the motor 100 from locking up. In the movement path of the magnetic devices 121-126 located in the various dollies 108-111, there may be inductive coils 127, 128, 129, 130, 131 and 132. The inductive coils 127-132 are shaped to each define a respective interior region 160, 161, 162, 163, 164 and 165 positioned centrally within the loops of each of the inductive coils 127-132. The inductive coils 127-132 create an induced current when the magnetic devices 121-126 move to a position near the inductive coils 127-132, and move in and away from the interior regions 160-165 of the inductive coils 127-132. The magnetic devices 121-126 may enter a portion of the respective interior regions 160-165 of the inductive coils 127-132.

The inductive coils 127-132 may be connected to a current load to excite other magnetic devices not shown in FIG. 1, or any of the magnetic devices 113-126 shown in FIG. 1. In particular, the inductive coils 127-132 may excite electromagnets utilized as any or all of the magnetic devices 113-126, which would be effectively provided with a pulsed electric current of minimum or sustained duration, which duration is enough to maintain rotation of the force transmission device 112 and the drive shaft 107 and therefore produce a desired output of torque. The pulsed electric current may be used to prevent the motor 100 from locking-up. In addition, the inductive coils 127-132 may power other devices and/or create excess energy. For a given system of such type, the output power is a function of the number of times that there is a relative movement of the magnetic devices 121-126 relative to the inductive coils 127-132, and the output of the inductive coils 127-132 per unit time (e.g., number of loops in the coil windings of the inductive coils 127-132).

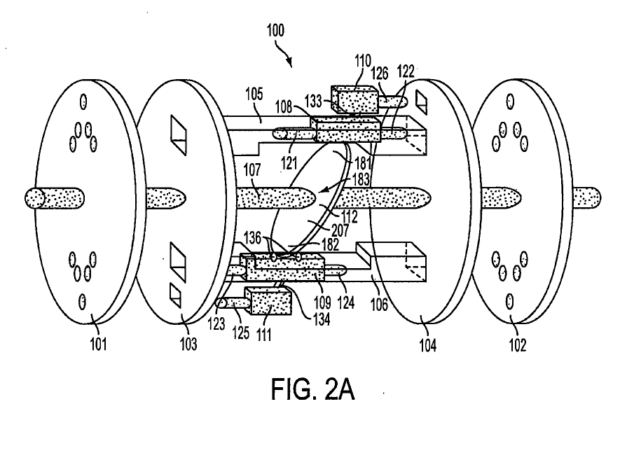

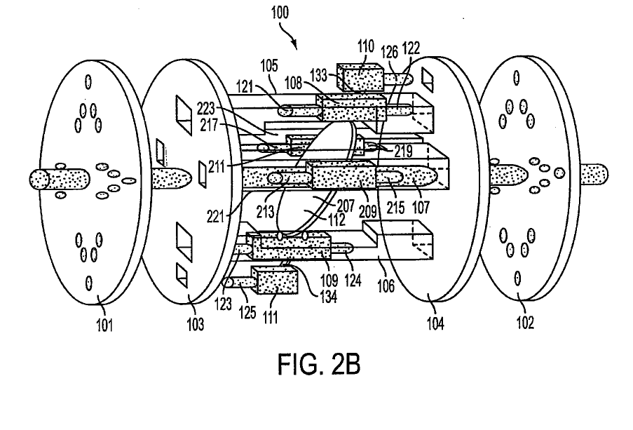

The first piston dolly 108 and second piston dolly 109 each move along respective traveling systems 105 and 106, which, in the case of a 4-pulse motor, include only two traveling systems 105 and 106. In the case of an 8-pulse motor (shown in FIG. 2B), there are four traveling systems with one piston dolly running along or through each traveling system.

FIG. 2A illustrates a perspective view of the motor 100 for a 4-pulse motor, including two piston dollies 108 and 109 with two magnetic devices 121, 122 and 123, 124 per dolly. In this embodiment, the force transmission device 112 is a swash plate 207. FIG. 2B illustrates a perspective view of the motor 100 for an 8-pulse motor. In this embodiment, four piston dollies 108, 109, 209 and 211 are coupled to the force transmission device 112. Two magnetic devices are fixed to each piston dolly 121, 122, 123, 124, 125, 126, 213, 215, 217 and 219. The third dolly 209 and fourth dolly 211 travel laterally along the axis of the drive shaft 107 along respective traveling systems 221 and 223.

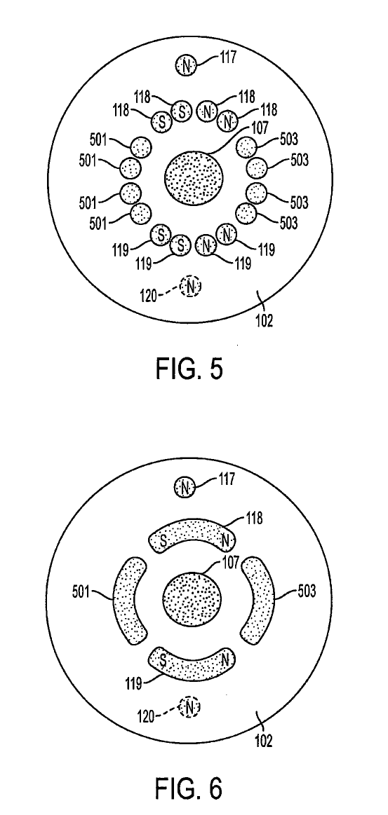

It is additionally worth noting the positions of the magnetic devices on the first and second flywheels 102 and 101 as shown in FIGS. 2A and 2B represent one embodiment of the positions of the magnetic devices. The positions may be varied, as shown in FIGS. 5 and 6, and as discussed in relation to FIGS. 5 and 6.

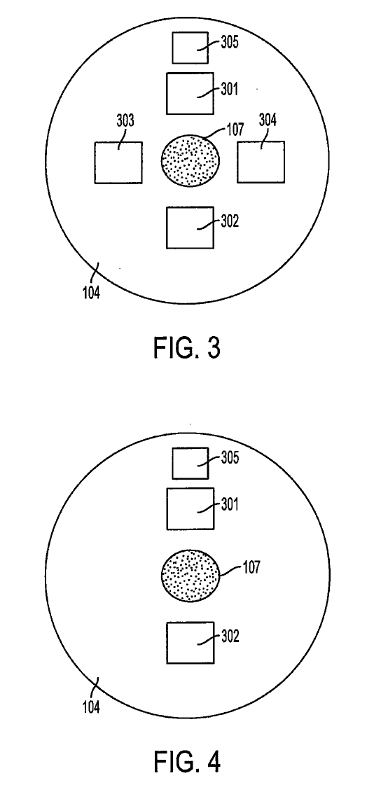

FIG. 3 illustrates the first shielding device 104 designed for an 8-pulse motor configuration, including four piston dollies with two magnetic devices attached. The first shielding device 104 may be configured as a shutter plate having flat, disk-like, or plate-like shape and a plurality of apertures 301, 302, 303, 304, 305, or cut-outs. The apertures 301, 302, 303 and 304 are positioned generally equidistant from the axis 151 (not shown) of the drive shaft 107. However, one aperture 305 is positioned towards a top portion of the first shielding device 104, to accommodate the positioning of the first anti-lock dolly 110. The second shielding device 103 may similarly have a plurality of apertures. However, the second shielding device 103 may not have a top-most aperture 305 positioned near a top portion of the second shielding device 103. Rather, the second shielding device 103 may have an aperture positioned near a bottom portion of the second shielding device 103, to accommodate the second anti-lock dolly 111. The bearings 137 and 138 (shown in FIG. 1) are used to prevent movement of the shielding devices 104 and 103 when the drive shaft 107 rotates.

Each aperture 301, 302, 303, 304 and 305 is used to allow a respective magnetic device 122, 124, 219, 215, 126, to pass through a portion of the aperture 301, 302, 303, 304 and 305 or to move to a position near each aperture 301, 302, 303, 304 and 305. The apertures in the two shielding devices 103 and 104 are used to shield and expose the magnetic devices 121, 122, 123, 124, 125, 126, 213, 215, 217, 219 located in the dollies 108, 109, 110, 111, 209 and 211 to the magnetic devices 113-120 coupled to the first flywheel 102 and the second flywheel 101.

FIG. 4 shows the first shielding device 104 with apertures 301, 302 and 305 designed for a 4-pulse motor, having two piston dollies with two magnetic devices attached. The second shielding device 103 may have similar apertures, in varied locations, as discussed above in relation to FIG. 3. In addition, it is understood that the apertures in the first and second shielding devices 104 and 103 may have varied sizes and positions to provide an equivalent operation.

FIG. 5 illustrates the first flywheel 102 with a plurality of magnetic devices 117-120, and 501, 503 coupled the first flywheel 102. The magnetic devices 118 positioned near the top of the first flywheel 102, the magnetic devices 501 and 503 positioned near the sides of the first flywheel 102, and the magnetic devices 119 positioned near the bottom of the first flywheel 102 may be each spaced generally equidistant from the axis 151 (shown in FIG. 1) of the drive shaft 107. The spacing corresponds to the position of the respective apertures 301, 302 shown in FIG. 4 and apertures 301, 302, 303 and 304 shown in FIG. 3. In addition, the magnetic device 117 is spaced above the magnetic devices 118, corresponding to the position of the respective aperture 305 shown in FIGS. 3 and 4. The magnetic devices 117-120 have a specific spacing between them to allow for a precise timing as the magnetic devices 122, 124 and 126 located in the dollies are exposed to the magnetic devices 117, 118, 119 and 120 on the first flywheel 102, as the apertures 301, 302 and 305 (and apertures 303 and 304 in the eight-pulse motor) in the first shielding device 104 allow. However, it is understood the spacing of the magnetic devices 117, 118, 119, 120 and 501, 503 on the first flywheel 102 may be varied from those shown in FIG. 5 to produce an equivalent result. The varied spacing may also change the timing of the motor 100.

FIG. 6 illustrates the first flywheel 102 with magnetic devices 118, 119, 501 and 503 having a varied shape. In this embodiment, the magnetic devices 118, 119, 501 and 503 have a kidney shape as the shape, size and spacing may be different depending on the application of the motor and the output desired. Thus, the same magnetic device 118 may present two, opposite magnetic polarities to the magnetic devices 122 and 124. The magnetic devices may be configured in a variety of equivalent shapes, thus the shapes are not limited to a circular or kidney-shape.

The second flywheel 101 will include similar magnetic devices in similar positions as discussed above in relation to FIGS. 5-6. The polarities of the magnetic devices shown in FIGS. 5-6, for both the first flywheel 102 and the second flywheel 101 may be configured to divide the first flywheel 102 and the second flywheel 101 into halves, with one half of each flywheel 102 and 101 configured to present a north pole (or positive pole) magnetic device, and the other half of each flywheel 102 configured to present a south pole (or negative pole) magnetic device. Thus, for the first flywheel 102, only north pole magnetic devices are attached to a first half of the first flywheel 102, and only south pole magnetic devices are attached to a second half of the first flywheel 102. Equivalently, the polarities of the magnetic devices on the first half and second half of the first flywheel 102 may be flipped (and the polarities of the magnetic devices on the first half and the second flywheel 101 may also be flipped). As shown in FIG. 5, one magnetic device 117 may be located at a position between the divide between the north pole magnetic devices and the south pole magnetic devices. As discussed in relation to FIG. 15, the magnetic device 117 prevents, for example, the first shielding device 104 from exposing an equal north and south polarity to, for example, magnetic device 122 at a lock-up point.

In addition, the polarity of the magnetic devices may be modified in alternative modes of operation. For example, if the polarity of the magnetic devices 122 and 121 are different, then the polarities of the magnetic devices on the first flywheel 102 and second flywheel 101 will need to be correspondingly modified.

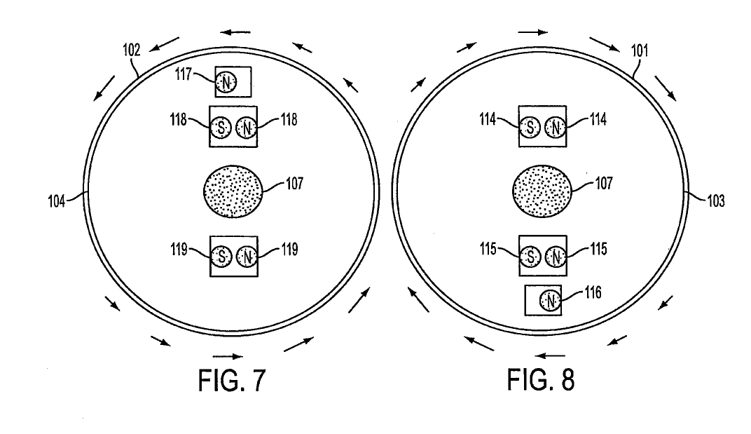

FIG. 7 illustrates a front view of the first shielding device 104 and the first flywheel 102 as the magnetic devices located in the dollies would see the magnetic devices 117-120 located in the first flywheel 102 through the apertures located in the first shielding device 104. As the first flywheel 102 rotates, the magnetic devices 117, 118, 119, 120, 501 and 503 located in the first flywheel 102 are shielded and/or exposed to more or less of the magnetic devices 122, 124 and 126 located in the dollies 108, 109 and 110. Thus, the first shielding device 104 simultaneously exposes a magnetic device 117-120, 501 and 503 and shields a magnetic device 117-120, 501 and 503 to the magnetic devices 122, 124 and 126 located in the dollies 108, 109 and 110. The resulting magnetic attraction and repelling causes the motor 100 to rotate. FIG. 8 illustrates the second flywheel 101 as it similarly rotates and exposes its magnetic devices to the magnetic devices located in the dollies 108, 109, 111.

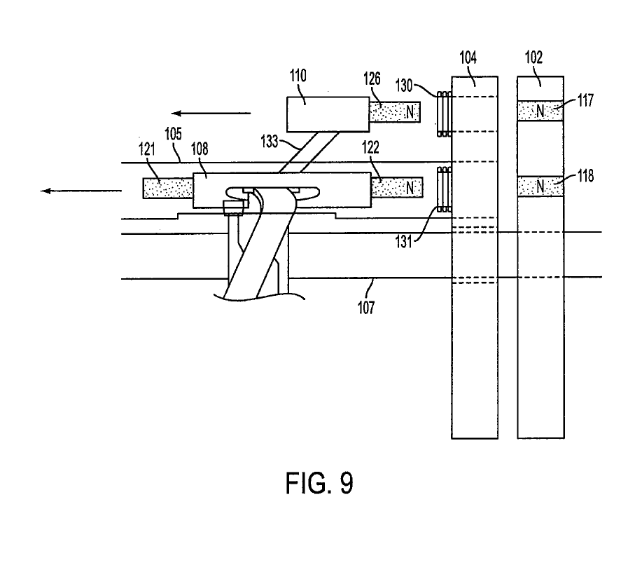

FIG. 9 illustrates how the magnetic devices 122 and 126 located on the first piston dolly 108 and the anti-lock dolly 110 are exposed through the apertures located on the shielding device 104 to like pole magnetic devices 117 and 118 located in the first flywheel 102. Since the repulsive force between the magnetic devices 126, 122, 117 and 118 is strongest when they are closest together, the magnetic devices 122 and 126 in the dollies 108 and 110 are driven away by this superior thrust along their trailing edge. The interaction results in like magnet poles repelling each other thereby both dollies 108 and 110 get pushed in a backward direction along the axis 151 of the drive shaft 107 by the like magnetic devices 126, 122, 117 and 118. This repelling action causes the first piston dolly 108 to provide a force to the force transmission device 112, forcing it to rotate around its center. Since the force transmission device 112 is attached to the drive shaft 107, this causes the drive shaft 107 to rotate. FIG. 9 also illustrates how the first piston dolly 108 moves along the trailing path or traveling system 105 which connects both shielding devices 103 and 104.

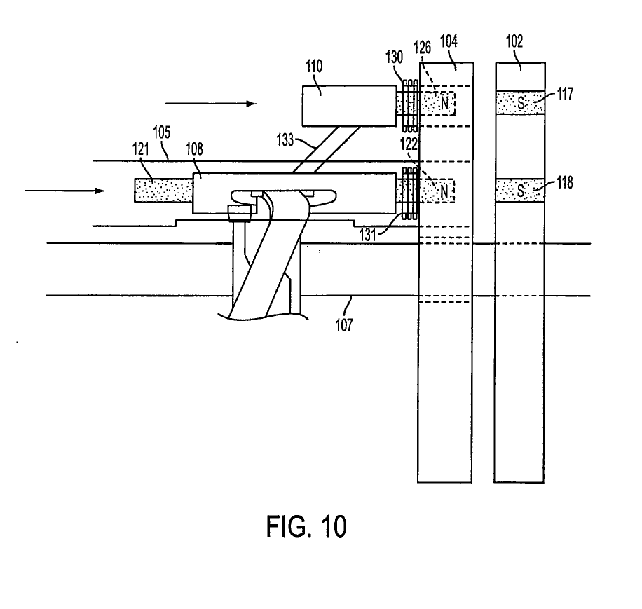

FIG. 10 illustrates the magnetic devices 122 and 126 located on the first piston dolly 108 and the anti-lock dolly 110 being attracted through the apertures in the first shielding device 104 by opposite pole magnetic devices 117 and 118. This attraction causes the magnetic devices 122 and 126 to move the dollies 108 and 110 in a forward direction towards the first flywheel 102, thus causing the force transmission device 112, the drive shaft 107, and the first and second flywheels 102 and 101, to rotate. FIG. 10 also illustrates how the magnetic devices 126 and 122, may generate a current or voltage as they move in and away from inductive coils 130 and 131. This current or voltage may be used to excite some or all of the magnetic devices 113-126 used in the motor 100, if electromagnets are used, which might be excited for a very brief or long moment, particularly in the case of magnetic devices 113, 116, 117 and 120 to help in the rotation of the motor 100 to avoid system lock-up. Also, part of all of the voltage generated by the inductive coils 130, 131 can be used to power other devices, and it can be partially or fully stored in batteries.

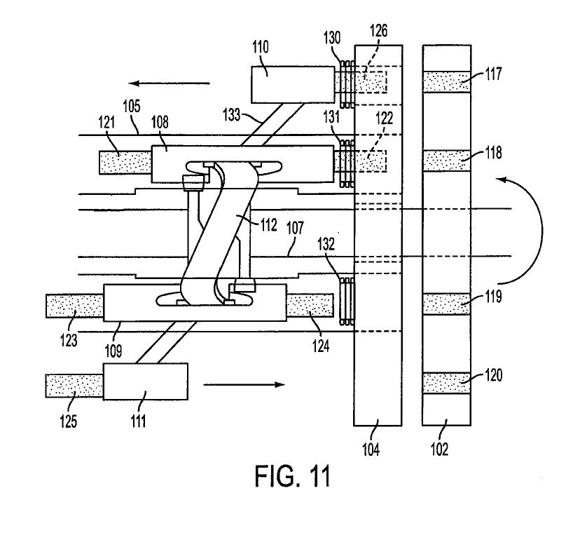

FIG. 11 illustrates how the rotation of the force transmission device 112, the drive shaft 107 and the first flywheel 102 and second flywheel 101 generates torque. When the first piston dolly 108 and the first anti-lock dolly 110 are repelled from the first flywheel 102, the second piston dolly 109 is attracted to the first flywheel 102 (however, the first anti-lock dolly 110 need not be needed for operation). The force is enhanced by the magnetic devices exposed by the second flywheel 101. The movement of the first piston dolly 108 and the second piston dolly 109 in opposite directions along the axis 151 of the shaft 107 transmit a force to the force transmission device 112, which produces a torque.

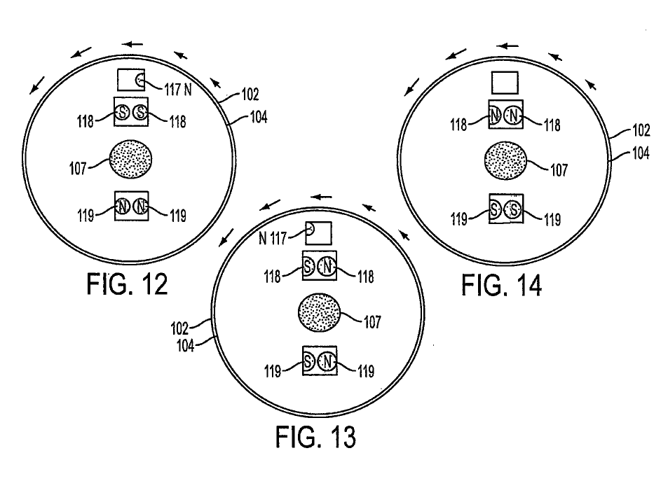

FIG. 12 illustrates a front perspective view of the first flywheel 102 and the first shielding device 104 as the magnetic devices 122, 124 and 126 located in the dollies 108, 109 and 110 are exposed through the apertures in the first shielding device 104 to the magnetic devices 117, 118 and 119 in the first flywheel 102. As the first flywheel 102 rotates, and as the apertures in the first shielding device 104 allow, the magnetic device 122 located in the first piston dolly 108, gets attracted by opposite magnetic pole (e.g., south/south) devices 118 located in the first flywheel 102. Likewise, the magnetic device 124 located in the second piston dolly 109 gets repelled (less strongly in this case because of the distance) by the similar pole magnetic device 119 located in the first flywheel 102. An opposite effect is produced by the second flywheel 101 (e.g, a opposite direction of force). As the first flywheel 102 keeps rotating, the magnetic device 126 located in the first anti-lock dolly 110 starts to see the same pole magnetic device 117 located in the first flywheel 102. All this attraction causes the dollies 108 and 110 to apply a force to the force transmission device 112 making it rotate, which causes the drive shaft 107 to rotate. The first and second flywheels 102 and 101 also rotate since they may be firmly attached to the drive shaft 107 as well.

FIG. 13 illustrates how the rotation of the first flywheel 102 exposes the magnetic device 122 to both south pole and north pole magnetic devices 118 located in the first flywheel 102. FIG. 13 illustrates the system at, or near, the possible lock-up point of the system. Likewise, the magnetic device 124 starts to see both south pole and north pole magnetic devices 119 in the first flywheel 102. In addition, the first anti-lock dolly 110 sees a north pole magnetic device 117 exposed through the first shielding device 104. The first anti-lock dolly 110 and the first dolly 108 therefore see a net north pole repulsive force from the first flywheel 102. The magnetic device 117 is positioned between the two opposite pole magnetic devices to assure the first piston dolly 108 never feels an equal like pole and opposite pole force. Both the first flywheel 102, which has some inertia, and the repelling action caused by the magnetic devices 122, 126 seeing net like-pole magnetic devices 117, 118 help the motor 100 rotate and prevent lock-up. Now, dollies 110 and 108 start to be pushed away from the first flywheel 102 whereas in FIG. 12 they were being pushed in towards the first flywheel 102.

An additional method to prevent against lock-up of the system may be to increase the dimensions or mass of the first flywheel 102 and second flywheel 101, increasing the inertia of the flywheels 102 and 101. The increased inertia of the first and second flywheel 102 and 101 will increase the angular momentum of the flywheels 102 and 101, and will help rotate the motor 100 away from the lock-up point.

FIG. 14 illustrates how the magnetic device 122 now sees (after the possible lock-up point) only like pole magnetic devices 118, and the magnetic device 124 now sees only opposite pole magnetic devices 119. In this configuration, the dollies 108 and 110 are being pushed away from the first flywheel 102 and the first shielding device 104, causing the rotation of the force transmission device 112, the drive shaft 107 and the first and second flywheels 102 and 101. The direction of motion of the first piston dolly 108 depends on the polarity of the magnetic device exposed to the first piston dolly 108.

The rotation of the first flywheel 102 continues as the first piston dolly 108 travels in directions towards and away from the first shielding device 104. Thus, a magnetic device having a positive polarity, and positioned at a first end of the flywheel, near the aperture, will eventually change positions with a magnetic device positioned at a second end of the flywheel and having a negative polarity. The magnetic device with the negative polarity will eventually rotate to a position near the aperture, causing the first piston dolly 108 to move in an opposite direction along the axis 151 of the drive shaft 107.

This same attraction and repelling takes place on the second flywheel 101 and second shielding device 103. However, when the magnetic device 122 is attracted to an opposite pole magnetic device 118 shown in FIG. 12, the magnetic device 121 is repelled by a like-pole magnetic device 114 coupled to the second flywheel 101. It is this interaction between both sides of the motor 100 that keeps the motor 100 rotating.

The eight-pulse motor shown in FIG. 2B operates similar to the four-pulse motor described in FIGS. 12-14. However, as shown in FIGS. 2B and 3, the eight-pulse motor includes additional dollies 209 and 211 and additional apertures 303 and 304. The eight-pulse motor operates as two four-pulse motors combined. Thus, when the first piston dolly 108 is near the first shielding device 104, and the second piston dolly 109 is near the second shielding device 103, the third piston dolly 209 and fourth piston dolly 211 are generally positioned at a middle point between the first and second shielding devices 104, 103. When the first piston dolly 108 and second piston dolly 109 move to the middle point between the first shielding device 104 and the second shielding device 103, the third piston dolly 209 moves near the first shielding device 104, and the fourth piston dolly 211 moves near the second shielding device 103. In this manner, the total output of the motor 100 increases as more force is transferred to the force transmission device 112.

FIGS. 15 and 16 illustrate how throttling and/or start up of the motor 100 may be achieved by moving the first and second flywheels 102 and 101 in and away from the respective first and second shielding devices 104 and 103. The throttling may be done manually, mechanically, electrically, or through a combination of any of the methods. In this configuration, the first flywheel 102 and second flywheel 101 are both slidably coupled to the drive shaft 107 through respective bearings 1501 and 1502 (or other frictionless methods). The first flywheel 102 and second flywheel 101 may then move laterally along the axis 151 of the drive shaft 107. The closer the respective distances 1501 and 1503 of the first and second flywheels 102 and 101 to the respective first and second shielding devices 104 and 103, the magnetic devices in both the flywheels 102 and 101 and the dollies 108, 109, 110 and 111 move closer. Thus, the magnetic devices interact more strongly, the drive shaft 107 spins more quickly, and the motor produces more torque, as shown in FIG. 16. However, as the first and second flywheels 102 and 101 move away from the respective first and second shielding devices 104 and 103, the drive shaft 107 spins slower and the motor 100 produces less torque, to a point where the motor 100 may reach a stall due to the lack of interaction among the magnetic devices.

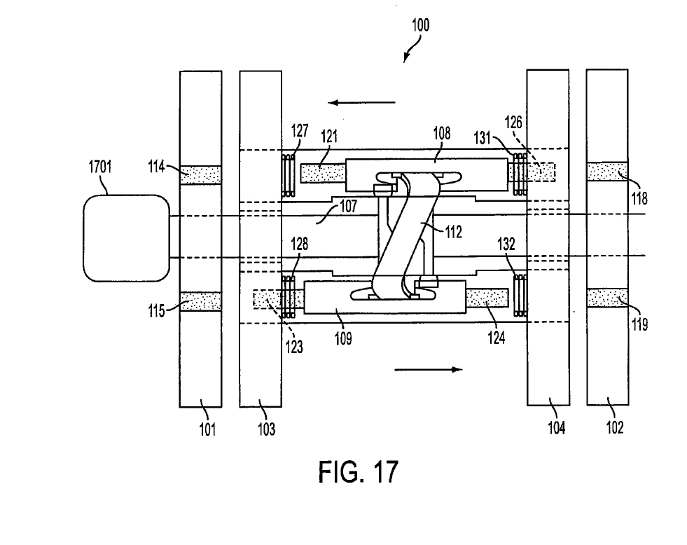

The force transmission device 112 may comprise a cam, a sinusoidal cam, a swash plate, a swivel plate, a disc, or the equivalent. The magnetic devices can be located in the first flywheel 102 and second flywheel 101 flush with the surface, at an angle, etc, and can be made of different sizes, natures, and shapes. Some cooling may exist (mostly oil pumping to reduce friction and heat) in the areas with the most friction (areas with bearings 135, 136, 137, 138, 1501 and 1502). The motor 100 may be started through a starter device 1701, shown in FIG. 17 (the energy provided to the starter might come from excess energy generated and stored by the motor or from an external source of energy) or, as explained in FIGS. 15 and 16, by moving the first and second flywheels 102 and 101 in and away from the respective first and second shielding devices 104 and 103.

FIG. 17 illustrates the starter device 1701 coupled to one end of the drive shaft 107. The starter device 1701 may comprise an electric motor, or a mechanical crank system engaged with the drive shaft 107 and configured to provide an initial torque to the drive shaft 107. The initial torque is transferred through the force transmission device 112 to move the first dolly 108 and second dolly 109 laterally along the axis 151 of the drive shaft 107. The initial torque additionally rotates the first flywheel 102 and second flywheel 101. In this manner, the motor 100 begins the operation illustrated in FIGS. 9, 10 and 11. The starter device 1701 provides the initial torque to the drive shaft 107 until the motor 100 reaches the desired rpm, or delivers the desired electrical output. In addition, the starter device 1701 may be powered in part by electrical energy produced by the inductive coils 127, 128, 131 and 132, stored energy in batteries (the batteries powered by the system or charged by an external source), any other electrical generation device delivering a current generated by the motor 100, or an outside power source.

The starter device 1701 need not be fixed to one end of the drive shaft 107 to provide the initial torque to the drive shaft 107. The starter device 1701 may be fixed to either end of the drive shaft 107, or may be directly coupled to provide a torque to the first or second flywheels 102 and 101. Moreover, the starter device 1701 may comprise a plurality of motors engaged with multiple components of the motor 100 to provide an initial torque. In addition, the starter device 1701 may include any other type of equivalent starter mechanisms, including a combustion engine.

FIG. 17 additionally illustrates a configuration of the motor 100 that does not include the first anti-lock dolly 110 and the second anti-lock dolly 111. This configuration illustrates the anti-lock dollies may not be necessary for operation of the motor 100.

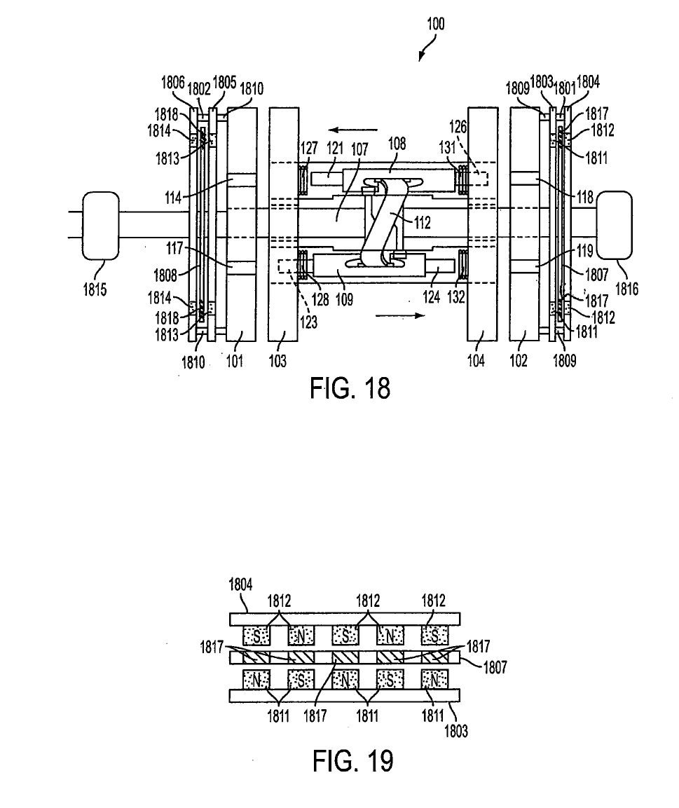

FIG. 18 illustrates one embodiment of the motor 100 including a first electric generator device 1801 coupled to the first flywheel 102 and a second electric generator device 1802 coupled to the second flywheel 101. In addition, additional electric generator devices 1815 and 1816 are illustrated positioned along the drive shaft 107. The first electric generator device 1801 may be configured to include a first rotor 1804, a second rotor 1803, a first stator 1807, and a first attachment device 1809. The first rotor 1804 includes a plurality of magnetic devices 1812 coupled to the first rotor 1803, and the second rotor 1803 similarly includes a plurality of magnetic devices 1811 coupled to the second rotor 1803. The first stator 1807 includes a coil device 1817, which may comprise a plurality of coils coupled to the first stator 1807.

The first rotor 1804 and the second rotor 1803 have a generally disk-like shape, which may be similar to the shape of the first flywheel 102. The first attachment device 1809 may comprise a column, a plurality of columns, a disk-shaped device, or an equivalent structure, connecting the first rotor 1804 to the second rotor 1803, and the first and second rotors 1804 and 1803 to the first flywheel 102. Thus, the first rotor 1804 and second rotor 1803 rotate with the first flywheel 102 as it revolves during operation. The first stator 1807 does not rotate with the first flywheel 102 and may remain fixed relative to the first rotor 1804 and the second rotor 1803 as they rotate. The first stator 1807 may be fixed to the drive shaft 107 through a bearing, to prevent rotation of the first stator 1807.

The second electric generator device 1802, similar to the first electric generator device 1801, may include third rotor 1806 and fourth rotor 1806, second stator 1818, a second attachment device 1810, magnetic devices 1813 and 1814 coupled to the respective third rotor 1806 and fourth rotor 1806, and a coil device 1818, which may comprise a plurality of coils coupled to the second stator 1818.

The operation of the motor 100 (e.g., as shown in FIGS. 9, 10 and 11) rotates the first flywheel 102, which correspondingly rotates the first rotor 1804 and the second rotor 1803 relative to the position of the first stator 1807. The magnetic devices 1812 and 1811 and coils of the coil device 1817 are configured such that an AC current is induced in the coil device 1817 due to the motion of the magnetic devices 1812 and 1811. The coils of the coil device 1817 may be wrapped around the first stator 1807 in a three-phase AC configuration, for example, in a three-phase delta configuration or a three-phase star configuration.

Different polarities of the magnetic devices 1812 and 1811 may be alternatively positioned on the first rotor 1804 and the second rotor 1803, as shown in FIG. 19. For example, the first rotor 1804 may have positive and negative poles placed alternatively on the surface of the first rotor 1804, and the polarities may be opposite to those on the second rotor 1803. The magnetic devices may be positioned on the first rotor 1804 equidistant from the drive shaft 107. The AC current generated by the first electrical generator device 1801 may be used in a similar manner to the current induced in the inductive coils 127-132; namely, the AC current may be used to excite other magnetic devices not shown in FIG. 1, or any of the magnetic devices 113-126 shown in FIG. 1.

The second electric generator device 1802 operates similarly to the operation of the first electric generator 1801 described above. It may be appreciated that no part of the first electric generator device 1801 or second electric generator device 1802 need be directly coupled to the drive shaft 107, or have a portion of the drive shaft 107 extend through a portion of first and second generators 1801 and 1802. The rotors 1804, 1803, 1805 and 1806 of the first and second generators devices 1801 and 1802 may be coupled to the respective first and second flywheels 102 and 101 to increase the inertial mass of the first and second flywheels 102 and 101. If the inertial mass of the flywheels 102 and 101 is increased, the motor 100 is less likely to lock-up because the increased angular momentum of the flywheels 102 and 101 will serve to rotate the flywheels 102 and 101 through the point where both negative and positive polarities are exposed through the shielding devices 104, as shown in FIG. 13. However, in one embodiment, components of the first electric generator device 1801 and the second electric generator device 1802 may additionally be coupled directly to the drive shaft 107 if the increased inertial mass is not desired. Furthermore, the stators may rotate with the flywheels, and the rotors may remain stationary. In addition, it is understood the first and second electric generator devices are not limited to the embodiments shown in FIGS. 18 and 19, and may comprise electric generators, turbines, or other equivalent methods of transferring kinetic energy into an electrical current.

The size and position of the coil devices 1817 and 1818, the number of coils in the coil devices 1817 and 1818, and the size of the wiring used in the coil devices 1817 and 1818 may be varied to dictate the energy output of the electric generators 1801 and 1802. In addition, the size, number, and position of the magnetic devices 1811, 1812, 1813 and 1814 may be varied to dictate the energy output of the electric generators 1801 and 1802. Typical energy outputs include, but are not limited to 12 V, 24 V, and 48 V of DC voltage after the AC voltage is rectified.

The additional electric generator devices 1815 and 1816 illustrated in FIG. 18, positioned along the drive shaft 107, may operate similarly to the operation of the electric generator devices 1801 and 1802. However, in this configuration, the additional electric generator devices 1815 and 1816 may not be coupled to the first flywheel 102 or second flywheel 101, but rather are coupled to the drive shaft 107. Accordingly, the equivalent stator devices or equivalent rotor devices (equivalent to those shown in FIG. 18) may be coupled to the drive shaft 107 in a manner to generate a current. The current generated by the additional electric generator devices 1815 and 1815 be used in a similar manner to the current induced in the inductive coils 127-132; namely, the current may be used to excite other magnetic devices not shown in FIG. 1, or any of the magnetic devices 113-126 shown in FIG. 1. It may be appreciated the additional electric generator devices 1815 and 1816 may comprise more than two electric generator devices positioned along the drive shaft 107, and may have a different configuration or output than the electric generator devices 1801 and 1802 (e.g., may have different shapes of coils and magnets, or may produce a DC output).

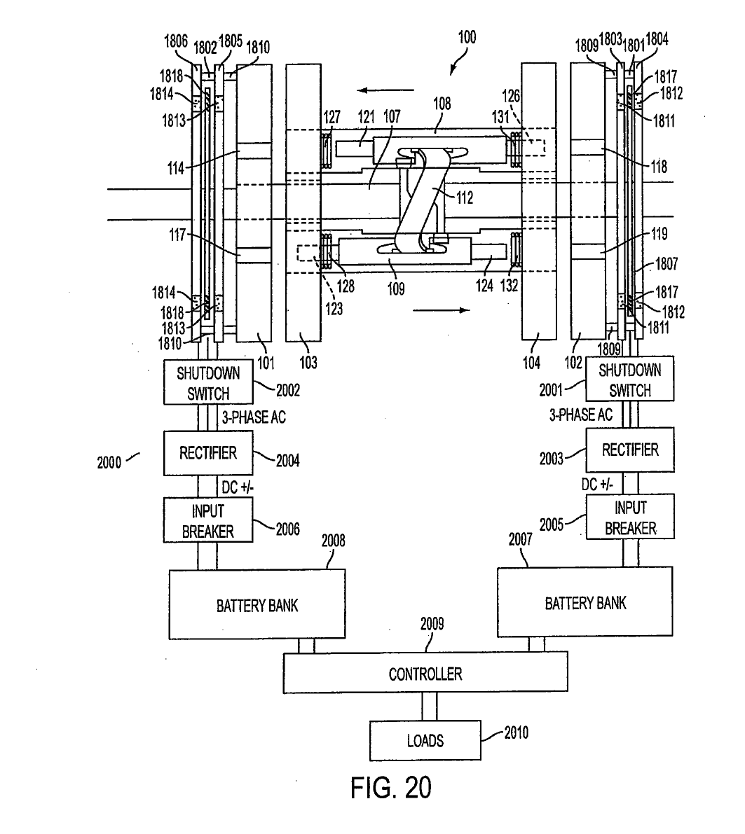

FIG. 20 illustrates an electrical processing system 2000, configured to process the AC current produced by the first electric generator device 1801 and the second electric generator device 1802. The electrical processing system 2000 may store the produced current in battery banks 2007 and 2008, or may distribute the current to additional loads 2010. The electrical processing system 2000 may include first and second shutdown switches 2001 and 2002 coupled to respective outputs from the first and second electric generators 1801 and 1802. As discussed above, in relation to FIG. 18, the outputs from the first and second electric generator devices 1801 and 1802 may be a three-phase AC current. The shutdown switches 2001 and 2002 allow the user to turn the output from the first and second electric generator devices 1801 and 1802 on or off, or may be used as a variable resistor to control the amount of current produced by the first and second electric generator devices 1801 and 1802. Rectifiers 2003 and 2004 are coupled to respective shutdown switches 2001 and 2002, to convert the three-phase AC current to a DC output. The input breakers 2005 and 2006 are coupled to the respective rectifiers 2003 and 2004 to control for power surges during operation of the motor 100 or during the start-up or shut-down of the motor 100. The battery banks 2007 and 2008 are coupled to the respective input breakers 2005 and 2006 to store the DC energy produced by the respective first and second electric generator devices 1801 and 1802.

Each battery bank 2007 and 2008 may comprise a single battery, or a plurality of batteries that are either fixed to the motor 100 or are removable and transportable from the motor 100. Thus, a user could operate the motor 100 to produce energy for use in a device unrelated to the motor 100. In addition, each battery bank 2007 and 2008 may serve as a reserve battery to power the motor 100 during start-up operations, as shown in FIG. 17, or to power any of the magnetic devices 113-126 shown in FIG. 1. A controller 2009 is coupled to the battery banks 2007 and 2008 which serves as a distribution network for the DC energy produced by the first and second electric generators 1801 and 1802. Accordingly, the controller 2009 may be coupled directly to input breakers 2005 and 2006, without the use of the battery banks 2007 and 2008. The controller may comprise a series of switches which may be mechanical in nature, electrical in nature, or be controlled through a computer processor. The loads 2010 represent any of the potential loads discussed above, including the starter motor 1701, other devices not shown in the previous figures, or any of the magnetic devices 113-126 shown in FIG. 1. The electrical processing system 2000 illustrated in FIG. 20 may additionally be coupled to distribute the energy produced by the inductive coils 127, 128, 129, 130, 131 and 132, shown in FIG. 1, or any other energy generation device coupled to the motor 100. It is also appreciated that the electrical processing system 2000 shown in FIG. 20 represents one possible configuration of the processing system 2000, and the components may be removed or modified to either store or distribute energy through the motor 100 or outside the motor 100, to produce an equivalent result.

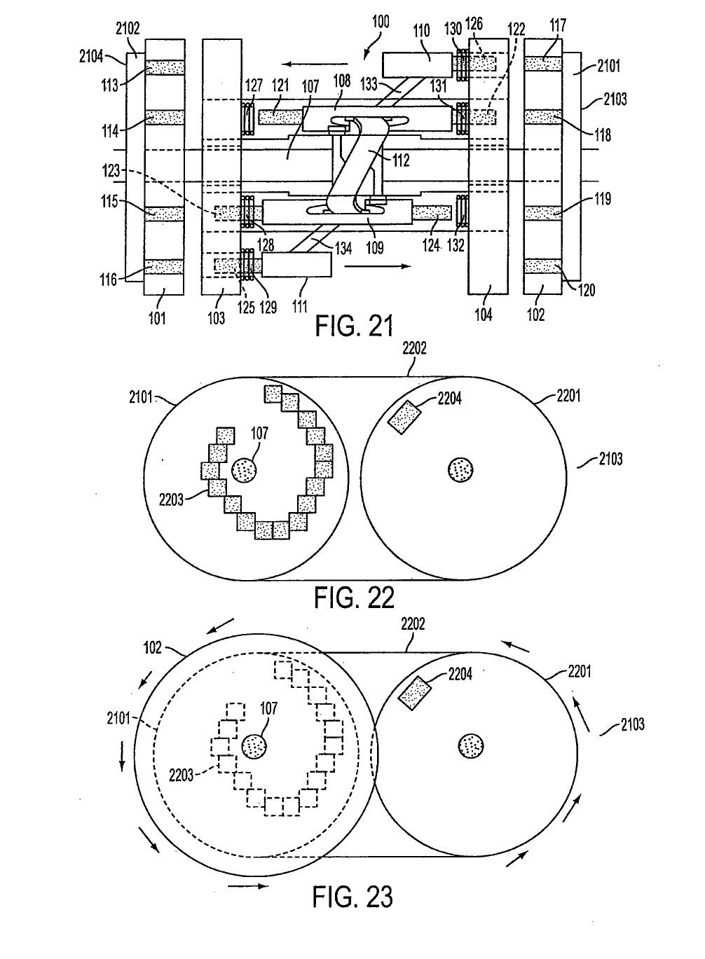

FIG. 21 illustrates a first timed force device 2103 and a second timed force device 2104 coupled to the motor 100. The first timed force device 2103 may comprise a first pulley system including a first pulley 2101. In addition, the second timed force device 2102 may comprise a second pulley system including a second pulley 2102. The first and second pulleys 2101 and 2102 are coupled to the respective first flywheel 102 and second flywheel 101. The first pulley 2101 and second pulley 2102 are configured to rotate with the respective first flywheel 102 and second flywheel 101, and each pulley 2101 and 2102 has a disk-like shape extending around the axis 151 of the drive shaft 107. The first pulley 2101 and second pulley 2102 may alternatively be coupled directly to the drive shaft 107. Each pulley 2101 and 2102 is configured to prevent lock-up in the motor 100, as described in relation to FIG. 13.

FIG. 22 illustrates a configuration of the first pulley system designed to prevent lock-up in the motor 100. First pulley 2101 includes a plurality of magnetic devices 2203 coupled to the first pulley 2101 and positioned in a spiral, elliptical, or nautilus pattern on the first pulley 2101. Hence, a portion of the magnetic devices 2203 are positioned near the center of the first pulley 2101, and a portion of the magnetic devices 2203 are positioned near the outer circumference of the first pulley 2101. The first pulley 2101 is coupled to a third pulley 2201 through an attachment device 2202 (e.g., a cable, chain, belt, or the equivalent). The attachment device 2202 assures that the first pulley 2101 and the third pulley 2201 rotate at the same rate. The third pulley 2201 includes a magnetic device 2204 coupled to the third pulley 2201 and positioned near the outer circumference of the third pulley 2201. The magnetic devices 2203 on the first pulley 2101 and the magnetic device 2204 on the third pulley 2201 are preferably of similar polarity, such that they repel each other 2203 and 2204 when positioned near each other. The magnetic devices 2203 on the first pulley 2101, and the magnetic device 2204 on the third pulley 2201 are positioned such that a strong tangential repelling force is applied to the first pulley 2101 from the third pulley 2201, when the first flywheel 102 is rotated to a position near the lock-up point, as shown in FIG. 13. In other words, when the first flywheel 102 rotates to a position near the lock-up point, the magnetic device 2204 on the third pulley wheel 2201 is at a position near the magnetic devices 2203 located on the first pulley wheel 2101. The spiral design of the magnetic devices 2203 forces the first pulley wheel 2101 in a tangential direction relative to the axis 151 of the drive shaft 107, aiding to rotate the first flywheel 102 away from the lock-up point.

FIG. 23 illustrates the first pulley wheel 2101 coupled to the first flywheel 102. The rotation of the first flywheel 102 controls the rotation and timing of both the first pulley wheel 2101 and second pulley wheel 2201, such that the strong tangential repelling force is always produced near the lock-up point. The magnetic devices 2203 located on the first pulley wheel 2101 may be alternatively positioned on the first pulley wheel 2101, with an alternative design (e.g., a non-spiral design), that produces an equivalent result. In addition, the polarities of the magnetic devices 2203 and the magnetic device 2204 may be varied to produce an attractive force. For example, the magnetic devices 2203 and 2204 may have opposite polarities, such that an attractive force rotates the first flywheel 102 near the lock-up point. The second pulley wheel 2102 may be configured in any manner as discussed above with regard to the first pulley wheel 2101; and a fourth pulley wheel (not shown) similarly coupled to the second pulley wheel 2102 may be configured in any manner as discussed above with regard to the third pulley wheel 2201. In addition, any of the magnetic devices disclosed above may comprise a single magnetic device or an equivalent plurality of magnetic devices.

It is also understood that the first timed force device 2103 and a second timed force device 2104 may comprise alternative systems than the pulley systems disclosed in FIGS. 21-23. The timed force devices 2103 and 2104 may comprise any mechanical or electrical mechanism that exerts a force to the system, the force exerted at a time near the lock-up point. Equivalent mechanisms may include a series of cam followers, an electrical pulse system, or the like. Furthermore, any equivalent mechanism may be combined with the pulley system, or component parts of the pulley system may be replaced with equivalent mechanisms. Moreover, the equivalent mechanisms may be attached directly to either of the flywheels. For example, a magnetic device could be placed directly on the perimeter of a flywheel, and a similar repelling system (shown in relation to the pulley system in FIGS. 22 and 23) can be used to provide a torque at or near a possible lock-up point. A magnetic device can be driven back and forth mechanically or electromechanically towards the magnetic device on the perimeter of the flywheel to produce a similar repelling or attracting effect on the system as shown in relation to FIGS. 21-23. Furthermore, a similar mechanism can be placed on any of the dollies directly.

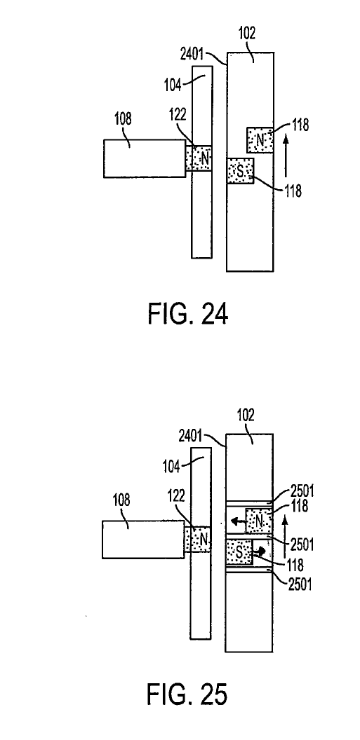

FIG. 24 illustrates a top view of a configuration of the magnetic devices 118 coupled to the first flywheel 102 wherein the magnetic devices 118 are positioned at a variable distance from the surface 2401 of the first flywheel 102. The configuration shown in FIG. 24 is utilized near the lock-up point, because both negative and positive polarities are exposed to the magnetic device 122 at this point. However, in this embodiment, one polarity is staggered, placed at an angle, or offset from the surface 2401 of the first flywheel 102. Thus, one polarity is near the surface 2401 of the first flywheel 102 and one polarity is far from the surface 2401 of the first flywheel 102. As the magnetic force felt by the magnetic device 122 depends on the distance from the magnetic devices 118, one polarity of magnetic device 118 will exert a stronger force on the magnetic device 118, thus preventing lock-up of the motor 100. The inertia of the first flywheel 102 will allow the motor 100 to rotate past the lock-up point, and the polarity of the staggered magnetic device will engage the magnetic device on the piston dolly. The other magnetic devices 119 on the first flywheel 102 (shown in FIG. 5) may be similarly configured. The second flywheel 101 and the magnetic devices 114 and 115 on the second flywheel 101 may be similarly configured.

FIG. 25 illustrates a top view of a configuration of the magnetic devices 118 that are slidably coupled to the first flywheel 102 wherein the magnetic devices 118 may be slid at precise moments towards or away from the surface 2401 of the first flywheel 102. In this configuration, similar to the configuration shown in FIG. 24, the magnetic devices 118 are positioned at variable distance from the surface 2401 of the first flywheel 102. However, in this embodiment, a mechanical or electromechanical means may move each magnetic device 118 towards or away from the surface 2401 of the first flywheel. For example, the magnetic devices 118 may be placed along tracks 2501 having actuators that slide each magnetic device 118. One polarity could be slid towards the surface 2401 and an opposing polarity could be slid away from the surface 2401 at the same time. In this manner, the first dolly 108 can be attracted or repelled from the first flywheel 102 at precise times. Both magnetic devices 118 could be moved or only one of the magnetic devices 118 could be moved. The other magnetic devices 119 on the first flywheel 102 may be similarly configured. The second flywheel 101 and the magnetic devices 114 and 115 on the second flywheel 101 may be similarly configured.

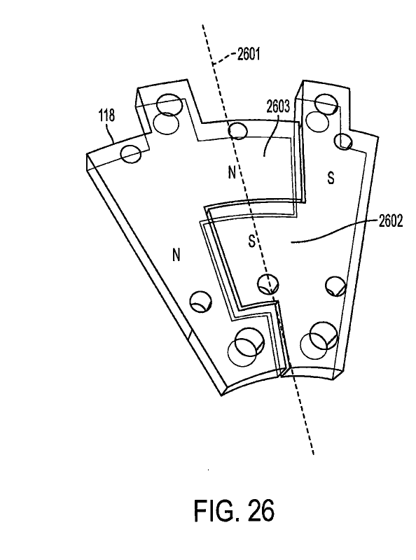

FIG. 26 illustrates a perspective view of an embodiment of a magnetic device 118 shaped to have two different poles overlap. A first overlapping portion 2602 may be sized differently than a second overlapping portion 2603. This magnetic device 118 would be exposed to a magnetic device, for example, magnetic device 122, at the lock-up point 2601 or position. The overlap assures the magnetic device 122 will not be exposed to an equivalent polarity at the lock up-point 2601, because the size of the overlapping portions 2602 and 2603 is different. The overlap aids the motor 100 to move past the lock-up point 2601. In one embodiment, the size of the overlapping portions 2602 and 2603 may be similar or different, and the overlap merely aids the magnetic device, for example, magnetic device 122, to see a similar pole and different pole at the same time. For example, if the magnetic device 122 has a positive polarity, and the magnetic device 122 is attracted to a negative polarity on the flywheel, then as the system approaches the lock-up point, the inertia of the flywheel will contribute to rotate the flywheel, to expose the positive polarity on the flywheel. The overlap will assist the magnetic device 122 to start to see a similar pole magnetic device at a time when the inertia of the flywheel acts to drive the system through the lock-up point. Thus, at a time when the piston has to move in a direction away from the flywheel, the overlap allows the magnetic device 122 to already see a similar pole magnetic device on the flywheel. The embodiment shown in FIG. 26 may be applied to any of the other magnetic devices on the first flywheel 102, or any of the magnetic devices on the second flywheel 101. In addition, the first overlapping portion 2602 and second overlapping portion 2603 may be alternatively spaced, in a fixed position, staggered position, or at an angle in relation to the surface of one of the flywheels 102 and 101, as described above with regard to FIG. 24. In addition, the first overlapping portion 2602 and second overlapping portion 2603 may each be movable in relation to the surface of one of the flywheels 102 and 101, as described above with regard to FIG. 24.

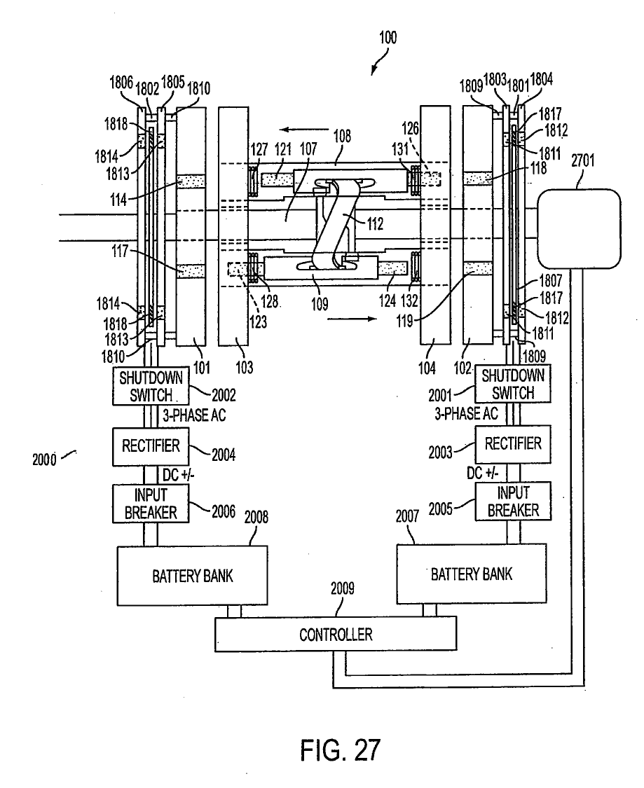

FIG. 27 illustrates the embodiment of the present invention, as shown in FIG. 20, of a torque device 2701 capable of providing pulses of torque to the drive shaft 107. The torque device 2701 may be coupled to the controller 2009 or to an external source of energy. As described above with in regard to FIG. 20, the controller 2009 may distribute energy to a plurality of loads 2010. One such load 2010 may include the torque device 2701. The torque device 2701 delivers pulses of torque to the drive shaft 107 when the motor 100 is at the position near the lock-up point. The pulse of torque aids to move the motor 100 past the lock-up point. In addition, the torque device may be configured to only deliver torque when the motor 100 is near the lock-up point. The torque device 2701 may be an electric and/or electromechanical device, including an electric motor, solenoid, actuator, servo, or the equivalent. The torque device 2701 may be actuated mechanically and/or electrically.

The torque device 2701 may be used to complement the other mechanical anti-lock mechanism disclosed above (e.g., anti-lock dollies; the pulley system; movable magnetic devices; electromagnets, and larger flywheels). However, the torque device 2701 drains electrical energy from the system, which may not benefit operation. Yet, torque device 2701 is only needed for mechanical lock-ups, which may typically occur approximately within a range of 1%-10% during maximum rotation in the four-pulse system. Additionally, the torque device 2701 may be the primary method of preventing lock-ups. Furthermore, the torque device 2701 may additionally be used for a speed control, to vary a speed of the motor 100 or to assure the motor 100 maintains a certain speed.

FIG. 28 illustrates a top view of an embodiment of the first piston dolly 108 configured to move laterally along the axis 151 of the drive shaft 107 along a traveling system 105, including first rail 2801 and a second rail 2082, rather than the tube shown in FIG. 1. Bearings 2803 are coupled to the first piston dolly 108, and also couple to the first rail 2801 and second rail 2082. The bearings 2803 allow the first piston dolly 108 to slide laterally to positions located between the first shielding device 104 and second shielding device 103. The first rail 2081 and second rail 2082 may offer less friction during lateral movement than the tube illustrated in FIG. 1. Rails may be used to replace any of the tubes shown in FIG. 2B, and may similarly be coupled to any of the other dollies 109, 209 and 211 shown in FIG. 2B.

While various motor system schemes have been described, the inventions disclosed herein may be implemented in various types of applications (generators, motor vehicles, etc) and mediums where permanent magnet or electromagnet energy generation motors is desired. Note that the size and nature of the magnets, coils, shaft, cams, flywheels, etc may vary depending on the application and output energy desired. The system may be solely used to rotate a drive shaft, or may solely be used to generate electrical energy. In addition, the number of dollies may vary from a single dolly system to a multiple dolly system extending beyond the four dollies disclosed above. Moreover, the system may operate utilizing only one flywheel and one shielding device. In addition, any magnetic device discussed above may comprise one magnetic device or a combination of magnetic devices.

Furthermore, the presence of the devices to prevent the lock-up of the system are used because it may be difficult to find a material with which to construct a shielding device that can entirely block the magnetic field of the magnetic devices. No anti-lock device may be necessary if such a shielding material is used.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

What is claimed is:

1. A motor comprising:
a drive shaft configured to rotate about an axis;
a first flywheel coupled to the drive shaft;
a force transmission device coupled to the drive shaft;
a first shielding device coupled to the drive shaft and positioned between the first flywheel and the force transmission device;
a first piston dolly coupled to the force transmission device, the first piston dolly configured to move laterally along the axis of the drive shaft;
a first magnetic device coupled to the first piston dolly;
a second piston dolly coupled to the force transmission device, the second piston dolly configured to move laterally along the axis of the drive shaft; and
a second magnetic device coupled to the second piston dolly.

2. The motor of claim 1 further comprising:
a second flywheel coupled to the drive shaft;
a second shielding device coupled to the drive shaft and positioned between the second flywheel and the force transmission device; and
wherein the drive shaft has a first end and a second end, the first flywheel being coupled to the first end of the drive shaft, the second flywheel being coupled to the second end of the drive shaft, and the force transmission device being positioned between the first flywheel and the second flywheel.

3. The motor of claim 1 further comprising a plurality of magnetic devices coupled to the first flywheel, one of the plurality of magnetic devices coupled to the first flywheel being magnetically engaged with the first magnetic device.

4. The motor of claim 3 wherein the plurality of magnetic devices are coupled to the first flywheel at positions being equidistant from the axis of the drive shaft.

5. The motor of claim 3 wherein a lateral movement of the first piston dolly rotates the plurality of magnetic devices relative to the axis of the drive shaft.

6. The motor of claim 3 further comprising:
an inductive coil; and
wherein the first shielding device has an aperture, the inductive coil being positioned adjacent to the aperture, a lateral movement of the first piston dolly causing a portion of the first magnetic device to move to a position near the inductive coil.

7. The motor of claim 6 wherein the first flywheel has a first end and a second end, one of the plurality of magnetic devices being positioned at the first end of the first flywheel and being positioned near the aperture, and one of the plurality of magnetic devices being positioned at a second end of the first flywheel, a lateral movement of the first piston dolly causing the one of the plurality of magnetic devices positioned at the second end of the first flywheel to rotate to a position near the aperture.

8. The motor of claim 3 wherein the shielding device is configured to shield one of the plurality of magnetic devices coupled to the first flywheel from the first magnetic device and expose one of the plurality of magnetic devices coupled to the first flywheel to the first magnetic device simultaneously.

9. The motor of claim 8 wherein a direction of a lateral movement of the first piston dolly along the axis of the drive shaft is based on a polarity of the one of the plurality of magnetic devices coupled to the first flywheel exposed to the first magnetic device.

10. The motor of claim 1 further comprising an anti-lock dolly coupled to the first piston dolly.

11. The motor of claim 1 further comprising:
a third dolly coupled to the force transmission device; and
a fourth dolly coupled to the force transmission device.

12. The motor of claim 1 wherein the force transmission device is selected from a group consisting of a sinusoidal cam and a swashplate.

13. The motor of claim 1 wherein the first flywheel is slidably coupled to the first end of the drive shaft, the first flywheel configured to move laterally along the axis of the drive shaft.

14. The motor of claim 1 further comprising a starter device coupled to the drive shaft, the starter device configured to provide an initial torque to the drive shaft at a time when operation of the motor starts.

15. The motor of claim 1 further comprising an electrical generator device coupled to the first flywheel.

16. The motor of claim 15 further comprising:
an electrical processing system coupled to the electrical generator device;
a torque device coupled to the drive shaft and the electrical processing system; and
wherein the electrical processing system is configured to distribute electrical energy to the torque device.

17. The motor of claim 1 further comprising a timed force device coupled to the first flywheel, the timed force device configured to exert a force on the first flywheel when the first flywheel is positioned at a lock-up point.

18. The motor of claim 3 wherein one of the plurality of magnetic devices is coupled to the first flywheel at a position near a surface of the first flywheel, and one of the plurality of magnetic devices is coupled to the first flywheel at a position far from the surface of the first flywheel.

19. The motor of claim 3 wherein the plurality of magnetic devices are slidably coupled to the first flywheel.

20. The motor of claim 1 further comprising a traveling system coupled to the first piston dolly, the traveling system being selected from a group consisting of a tube and a rail.
